(19) United States
(12) Patent Application Publication
(10) Pub. No.: US 2025/0014209 A1
(43) Pub. Date: Jan. 9, 2025

(54) IMAGE PROCESSING METHOD AND APPARATUS, AND ELECTRONIC DEVICE, STORAGE MEDIUM, COMPUTER PROGRAM AND COMPUTER PROGRAM PRODUCT

(71) Applicants: SENSETIME GROUP LIMITED, Hong Kong (CN); HONDA MOTOR CO., LTD., Tokyo (JP)

(72) Inventors: Ang LI, Hong Kong (CN); Qiuyi Guo, Hong Kong (CN); Qinhong Jiang, Hong Kong (CN); Isao Yamada, Hong Kong (CN); Tatsuya Suzuki, Hong Kong (CN)

(21) Appl. No.: 18/892,732

(22) Filed: Sep. 23, 2024

Related U.S. Application Data
(63) Continuation of application No. PCT/CN2022/129076, filed on Nov. 1, 2022.

(30) Foreign Application Priority Data
Mar. 24, 2022 (CN) 202210303559.6

(51) Int. Cl. G06T 7/70; G06T 5/10; G06T 7/20; G06V 10/25; G06V 20/56

(52) U.S. Cl. CPC G06T 7/70; G06T 5/10; G06T 7/20; G06V 10/25; G06V 20/56

(57) ABSTRACT

An image processing method and apparatus, and an electronic device, a storage medium, a computer program and a computer program product are provided. The method includes: at least two road image frames are obtained by an image collection assembly, which is arranged on a driving device; by using a phase correlation method, posture change information of the driving device between two road image frames among the at least two road image frames is determined; and posture information of the driving device is determined on based on the posture change information and reference posture information of the driving device.

### CROSS-REFERENCE TO RELATED APPLICATIONS

The present disclosure is a US continuation application of International Application No. PCT/CN2022/129076, filed on Nov. 1, 2022, which is filed based upon and claims priority to Chinese patent application No. 202210303559.6, filed on Mar. 24, 2022 and entitled “IMAGE PROCESSING METHOD AND DEVICE, ELECTRONIC EQUIPMENT AND STORAGE MEDIUM”. The disclosures of International Application No. PCT/CN2022/129076 and Chinese patent application No. 202210303559.6 are hereby incorporated by reference in their entireties.

### BACKGROUND

An accurate and robust calibration system is very important for a self-driving system, since the calibration system determines a reference coordinate system for measurement values output by various sensors and can improve accuracy and consistency during moving of a vehicle. An uneven road and acceleration and deceleration of the ego vehicle may cause posture changing of the ego vehicle relative to the ground.

Generally, this problem may be solved at both a software level and a hardware level. At the hardware level, generally, a high-precision inertial navigation positioning sensor may be used for providing accurate posture information, which is usually costly. At the software level, generally, feature point matching may be used for calculating posture changing, which is time-consumed.

### SUMMARY

The present disclosure relates to the technical field of computer vision, in particular to a method for image processing, an apparatus, an electronic device, a storage medium, a computer program, and a computer program product.

In embodiments of the present disclosure, a method for image processing, an apparatus, an electronic device, a storage medium, a computer program, and a computer program product are provided.

The solution of the disclosure is implemented as follows.

There is provided a method for image processing in an embodiment of the present disclosure, the method includes the following operations.

At least two frames of road images are obtained by an image acquisition component installed on a traveling device.

Information of posture changing, of the traveling device, between two frames of road images of the at least two frames of road images is determined by using a phase-only correlation method.

Posture information of the traveling device is determined based on the information of posture changing and reference posture information of the traveling device.

There is also provided an apparatus for image processing in an embodiment of the present disclosure, the apparatus includes an obtaining unit, a posture offset sensing unit, and a posture determination unit.

The obtaining unit is configured to obtain at least two frames of road images through an image acquisition component installed on a traveling device.

The posture offset sensing unit is configured to determine information of posture changing, of the traveling device, between two frames of road images of the at least two frames of road images by using a phase-only correlation method.

The posture determination unit is configured to determine posture information of the traveling device based on the information of posture changing and reference posture information of the traveling device.

There is also provided a computer-readable storage medium in an embodiment of the present disclosure. A computer program is stored in the computer-readable storage medium, and when the computer program is executed by a processor, the processor is caused to perform operations of the method in the embodiments of the present disclosure.

There is also provided an electronic device in an embodiment of the present disclosure. The electronic device includes a memory, a processor, and a computer program stored on the memory and executable by the processor. The processor, when executing the computer program, performs operations of the method in the embodiments of the present disclosure.

There is also provided a computer program in an embodiment of the present disclosure. The computer program includes computer-readable codes which, when being read and executed by a computer, cause the computer to perform some or all of the operations of the method in any embodiment of the present disclosure.

There is also provided a computer program product in an embodiment of the present disclosure. The computer program product includes a non-transitory computer-readable storage medium for storing a computer program which, when being read and executed by a computer, cause the computer to perform some or all of the operations of the method in any embodiment of the present disclosure.

### BRIEF DESCRIPTION OF THE DRAWINGS

To illustrate the technical solution of the embodiments of the present disclosure more clearly, the accompanying drawings required for the embodiments will be briefly described below. The accompanying drawings herein, which are incorporated in and constitute a part of the description, illustrate the embodiments conforming to the disclosure and, together with the description, serve to illustrate the technical solution of the disclosure. It should be understood that the accompanying drawings merely illustrated some embodiments of the present disclosure and thus should not be regarded as limitation of the scope. A person having ordinary skill in the art can obtain other drawings according to these accompanying drawings without paying inventive efforts.

FIG. 1 is a first flowchart of a method for image processing according to an embodiment of the present disclosure.

FIG. 2 is a flowchart of processing of phase offset information in a method for image processing according to an embodiment of the present disclosure.

FIG. 3 is a schematic diagram of phase offset information in a method for image processing according to an embodiment of the present disclosure.

FIG. 4 is a first structural schematic diagram of composition of an apparatus for image processing according to an embodiment of the present disclosure.

FIG. 5 is a second structural schematic diagram of composition of an apparatus for image processing according to an embodiment of the present disclosure.

FIG. 6 is a structural schematic diagram of composition of hardware of an electronic device according to an embodiment of the present disclosure.

### DETAILED DESCRIPTION

In the embodiments of the present disclosure, there are provided a method for image processing, an apparatus, an electronic device, a storage medium, a computer program, and a computer program product. The method includes: obtaining at least two frames of road images by an image acquisition component installed on a traveling device; determining information of posture changing, of the traveling device, between two frames of road images of the at least two frames of road images by using a phase-only correlation method; and determining posture information of the traveling device based on the information of posture changing and reference posture information of the traveling device. According to the technical solution of the embodiments of the present disclosure, the information of posture changing between road images is determined by the phase-only correlation method. Compared with the manner of adopting the high-precision inertial navigation positioning sensor, the embodiments of the present disclosure can reduce the cost while obtaining accurate posture information. Compared with the manner of calculating the posture information by using the method of feature point matching, the embodiments of the present disclosure can reduce the amount of calculation and are applicable to monocular vision sensors.

The present disclosure will be described in further detail below with reference to the accompanying drawings and detailed embodiments.

In the embodiments of the present disclosure, the terms “including”, “comprising” or any other variant thereof are intended to cover non-exclusive inclusions. Therefore, a method or an apparatus that includes a series of elements not only includes such elements, but also includes other elements not specified expressly, or may include inherent elements of the method or the apparatus. Without further limitations, elements limited by the statement “including a/an . . . ” do not exclude other associated elements existing in the method or apparatus that includes the elements. For example, operations in the method or units in the apparatus may be partial circuits, partial processors, partial programs or software, etc.

For example, the method for image processing provided in the embodiments of the present disclosure includes a series of operations, but the method for image processing provided in the embodiments of the present disclosure is not limited to the disclosed operations. Similarly, the apparatus for image processing provided in the embodiments of the present disclosure includes a series of modules, but the apparatus provided in the embodiments of the present disclosure is not limited to these modules expressly disclosed, and may also include other modules required for obtaining relevant information or processing based on the information.

The term “and/or” in the disclosure is only an association relationship for describing the associated objects, and represents that three relationships may exist, for example, A and/or B may represent the following three cases: A exists separately, both A and B exist, and B exists separately. In addition, the term “at least one of” used herein means any one of a plurality of objects or any combination of at least two of the plurality of objects. For example, the expression of including at least one of A, B or C may mean including any one or at least two elements selected from a set composed of A, B and C.

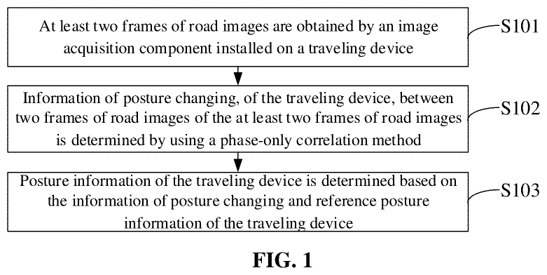

There is provided a method for image processing in an embodiment of the present disclosure. FIG. 1 is a first flowchart of a method for image processing according to an embodiment of the present disclosure. As illustrated in FIG. 1, the method includes operations S101 to S103.

At operation S101, at least two frames of road images are obtained by an image acquisition component installed on a traveling device.

At operation S102, information of posture changing, of the traveling device, between two frames of road images of the at least two frames of road images is determined by using a phase-only correlation method.

At operation S103, posture information of the traveling device is determined based on the information of posture changing and reference posture information of the traveling device.

In an embodiment of the present disclosure, the traveling device may be a self-driving vehicle, a vehicle loaded with an advanced driving assistant system (ADAS), a robot, or the like. The method for image processing in the embodiment of the present disclosure is applied to an electronic device, which may be an on-board device, a cloud platform or other computer devices. In some embodiments, the on-board device may be a thin client, a thick client, a microprocessor-based system, a minicomputer system, or the like installed on a vehicle. The cloud platform may be a distributed cloud computing technology environment including a minicomputer system or a mainframe computer system, or the like. In some possible implementations, the method for image processing may be performed by a processor invoking computer-readable instructions stored in a memory.

In an embodiment of the present disclosure, the on-board device may be communicatively connected to a sensor, a positioning apparatus, etc., of the vehicle. The on-board device may obtain, through the communicative connection, data collected by the sensor of the vehicle, geographical location information reported by the positioning apparatus and the like. In some embodiments, the sensor of the vehicle may be at least one of a millimeter-wave radar, a light detection and ranging, a camera, and the like. The positioning apparatus may be an apparatus for providing the positioning service based on at least one of the following positioning systems: a global positioning system (GPS), a Beidou satellite navigation system or a Galileo satellite navigation system.

In an example, the on-board device may be an ADAS which is installed on the vehicle. The ADAS may obtain real-time position information of the vehicle from the positioning apparatus of the vehicle, and the ADAS may also obtain, from the sensor of the vehicle, image data, radar data, and the like representing information of the surrounding environment of the vehicle. Alternatively, the ADAS may transmit traveling data of the vehicle including real-time position information of the vehicle to the cloud platform, so that the cloud platform may receive at least one of the real-time position information of the vehicle, the image data, the radar data, and the like representing information of the surrounding environment of the vehicle.

In an embodiment of the present disclosure, road images are obtained by an image acquisition component (i.e., the above-mentioned sensor, such as a camera) installed on the traveling device. The image acquisition component collects the road images or environmental images around the vehicle in real time when the traveling device is moving.

According to the technical solution of the embodiments of the present disclosure, the information of posture changing between the road images is determined by the phase-only correlation method. Compared with the manner of adopting the high-precision inertial navigation positioning sensor, the embodiments of the present disclosure can reduce the cost while obtaining accurate posture information. Compared with the manner of calculating the posture information by using the feature point matching method, the embodiments of the present disclosure can reduce the amount of calculation and are applicable to monocular vision sensors.

In some optional embodiments of the present disclosure, the operation of determining the information of posture changing of the traveling device between the two frames of road images of the at least two frames of road images by using the phase-only correlation method includes the following actions. Phase offset information between the two frames of road images is determined based on regions of interest in the two frames of road images. The information of posture changing, of the traveling device, between the two frames of road images is determined based on the phase offset information.

In the field of image processing, a region of interest (ROI) is a region selected from an image (i.e., the road image in the embodiments of the present disclosure), and the region is a focus of image analysis or processing. In some embodiments, the ROI may be determined in a manner of a square, a circle, an ellipse, an irregular polygon, or the like. In an embodiment of the present disclosure, the ROI in the road image is determined by taking a square as an example.

In the embodiments of the present disclosure, by setting the ROI in the road image, the phase offset information between the road images is determined based on the ROIs in the road images through the phase-only correlation method, and further, the information of posture changing, of the traveling device, between the two frames of road images is determined based on the phase offset information. Compared with the manner of calculating the posture information by using the feature point matching method, the embodiments of the present disclosure can greatly reduce the calculation amount.

In some optional embodiments, the ROI(s) in each frame of road image may be determined by the following manner. One or at least two ROIs in the each frame of road image is(are) determined. At least one of the one or at least two ROIs overlaps with horizon and/or includes a vanishing point.

In an embodiment of the present disclosure, one or at least two ROIs are set in each frame of road image. At least one of the one or at least two ROIs has at least one of following characteristics: overlapping with horizon, or including a vanishing point. In some embodiments, in the case that a road image includes one ROI, the ROI has at least one of following characteristics: overlapping with horizon, or including the vanishing point. In the case that a road image includes at least two ROIs, each of the at least two ROIs has at least one of following characteristics: overlapping with horizon, or including the vanishing point.

Alternatively, each of the at least two ROIs may also overlap with at least one other ROI.

A size and an aspect ratio of the ROI may be set according to actual needs, which is not limited in the embodiments of the present disclosure.

Generally, the road images are obtained by the image acquisition component installed on the traveling device. The traveling device generally travels on a road, i.e., the road images may generally include lane lines on the road. The vanishing point represents a visual intersection point, in the road image, of parallel lines in the actual road, such as lane lines or road edges. The ROI in the embodiment of the present disclosure includes the vanishing point.

In some optional embodiments, the at least one ROI is symmetrical with respect to horizon.

In some optional embodiments, the number of pixels of each edge of at least one ROI is n-th power of 2, n being a positive integer.

In an embodiment of the present disclosure, in order to facilitate image processing, the size of the at least one ROI may be a size easily processed by the image processing. For example, in the case that the image processing method includes a fast Fourier transform (FFT), the number of pixels of each edge of the at least one ROI is n-th power of 2, n being a positive integer.

In some optional embodiments, there is no moving object in the ROI; or, a proportion of the moving object occupying the ROI is less than or equal to a first threshold.

In an embodiment of the present disclosure, the selected ROI includes no moving object, or the proportion of the moving object(s), included in the selected ROI, occupying the ROI is small, for example, the proportion of the moving object(s) occupying the ROI is less than or equal to the first threshold. Therefore, the calculated phase offset information between the two frames of road images is not affected by the moving object(s) or is slightly affected by the moving object(s), and the obtained phase offset information and the posture offset information of the traveling device are more accurate. A value of the first threshold value may be set according to the actual situations, which is not limited in the embodiment of the present disclosure. In some embodiments, the moving object(s) may be other traveling device(s) (such as other vehicle(s)) in the road image.

In some embodiments, when the each frame of road image includes at least two ROIs, the at least two ROIs at least include a first ROI and a second ROI. The first ROI includes the vanishing point.

In other embodiments, the first ROI may also be referred to as a main ROI, and the second ROI may also be referred to as an auxiliary ROI. Under different scenarios, the electronic device may determine the phase offset information between the two frames of road images based on at least one of the first ROI and the second ROI in each of the two frames of road images.

Optionally, a size of the second ROI is smaller than a size of the first ROI.

Optionally, the second ROI is within the first ROI, or the second ROI is outside the first ROI, or the second ROI partially overlaps with the first ROI.

In some optional embodiments of the present application, the operation of determining the phase offset information between the two frames of road images based on the ROIs in the two frames of road images includes the operation that the phase offset information between the two frames of road images is determined based on ROI(s) in each of the two frames of road images.

In an embodiment of the present disclosure, in the case that the ROI includes no moving object, or the proportion of the moving object(s) occupying the ROI is less than or equal to the first threshold, in other words, the phase offset information between the two frames of road images is not affected by the moving object(s) or is slightly affected by the moving object(s), the phase offset information between the two frames of road images may be determined based on ROI(s) in each frame of road image.

In some optional embodiments of the present application, there is moving object(s) in the first ROI, then the operation of determining the phase offset information between the two frames of road images based on the ROIs in the two frames of road images includes the operation that the phase offset information between the two frames of road images is determined based on the second ROIs in the two frames of road images.

In an embodiment of the present disclosure, in the case that there is moving object(s) in the first ROI (such as the main ROI), there may be no moving object in the second ROI since the second ROI and the first ROI are deployed in different positions. Then the phase offset information between the two frames of road images is determined based on the second ROIs (such as the auxiliary ROIs) in the two frames of road images. In other embodiments, in the case that there is no moving object in the first ROI (such as the main ROI), then the phase offset information between the two frames of road images may be determined based on the first ROIs (such as the main ROIs) only; alternatively, the phase offset information between the two frames of road images may be determined based on the first ROIs and the second ROIs.

In some optional embodiments, in the case that an ROI in the first road image includes moving object(s), or in the case that the proportion of the moving object(s) occupying the ROI in the first road image is greater than or equal to a second threshold value, the phase offset information between the first road image and another road image is not determined by using the first road image. That is, the phase offset information between the first road image and another road image is not determined by using the first road image, in other words, the first road image is not used for calculating the phase offset information, thereby eliminating the influence of the moving object(s) in the ROI of the road image on the calculated phase offset information.

In some optional embodiments, each of ROI(s) in each of the two frames of road images includes moving object(s), the operation of determining the phase offset information between the two frames of road images based on the ROIs in the two frames of road images includes the following operations. First phase offset information between the two frames of road images is determined based on the ROIs in the two frames of road images; and a proportion of a region where the moving object(s) is located in the ROIs in the two frames of road images is determined respectively, and the phase offset information between the two frames of road images is determined based on the proportion and the first phase offset information.

In an embodiment of the present disclosure, in the case that both the ROIs in the two frames of road images for determining the phase offset information include the moving object(s), the calculated phase offset information between the two frames of road images (referred to as the first phase offset information) is corrected, so as to correct the influence of the moving object on the calculated phase offset information. For example, the electronic device may determine the proportion of the moving object(s) in a ROI occupying the ROI after calculating the first phase offset information based on the ROIs in the two frames of road images. For example, a detection frame including a moving object may be detected, and an overlapping area between the moving object and the ROI is determined (the moving object may be large, and not the whole moving object is in the ROI). Further, the proportion of a size (or area) of the overlapping area to a size (or area) of the ROI is determined, and the phase offset information between the two frames of road images is determined based on the proportion and the first phase offset information.

Alternatively, the proportion may be multiplied by the first phase offset information to obtain phase offset information between the two frames of road images.

In some optional embodiments, each frame of road image includes at least two ROIs, and the operation of determining the phase offset information between the two frames of road images based on the ROIs in the two frames of road images includes the following operations. Second phase offset information between the two frames of road images is determined based on each set of corresponding ROIs in the two frames of road images, herein, a position of a ROI, in each set of corresponding ROIs, in a road image of the ROI correspond to a position of the other ROI, in the set of corresponding ROIs, in a road image of the other ROI. One piece of second phase offset information is selected from at least two pieces of second phase offset information as the phase offset information between the two frames of road images; alternatively, median phase change information among the at least two pieces of second phase offset information is determined and the median phase change information is determined as the phase offset information between the two frames of road images; alternatively, an average value of the at least two pieces of second phase offset information is determined and the average value is determined as the phase offset information between the two frames of road images.

In an embodiment of the present disclosure, one road image includes at least two ROIs, for example, the road image 1 includes three ROIs, and the road image 2 includes three ROIs corresponding to the three ROIs in the road image 1. Each ROI in the road image 1 and the respective ROI, corresponding to the ROI in the road image 1, in the road image 2 may form a set of ROIs, the positions of the ROIs in each set of ROIs in their respective road images correspond to each other, and the second phase offset information between the two frames of road images may be calculated for each set of ROIs. In an implementation, one piece of second phase offset information is selected from at least two pieces of second phase offset information as the phase offset information between the two frames of road images, for subsequent calculation of the posture information of the traveling device. In a second implementation, a median phase offset information among the at least two pieces of second phase offset information may be determined, and the median phase change information is determined as the phase offset information between the two frames of road images. The median phase offset information may be determined by: sorting the at least two pieces of second phase offset information in a descending order or an ascending order, and selecting the second phase offset information located in the middle as the median phase offset information. In a third implementation, the at least two pieces of second phase offset information may be added to further obtain an average value, and the calculated average value is determined as the phase offset information between the two frames of road images.

In the above third implementations, before performing adding and averaging on the at least two pieces of second phase offset information, the method may further include the following operations. Abnormal second phase offset information may be removed from the at least two pieces of second phase offset information. After removing the abnormal value, the remaining pieces of second phase offset information may be added to obtain the average value, to obtain the phase offset information between the two frames of road images. Generally, different pieces of second phase offset information calculated based on various ROIs may be similar, that is, the differences among different pieces of second phase offset information may not exceed a certain threshold. Then, if a difference between a piece of second phase offset information and any other second phase offset information exceeds the threshold value, this piece of second phase offset information may be determined as the abnormal value, that is, the second phase offset information with a large difference from any other second phase offset information may be used as the abnormal value, which needs to be removed.

In some optional embodiments of the present disclosure, the operation of determining the phase offset information between the two frames of road images based on the ROIs in the two frames of road images may include the following operations. Sub-images corresponding to the ROIs in the two frames of road images are extracted respectively to obtain a first sub-image and a second sub-image. Gray-scale processing is performed on the first sub-image and the second sub-image, to obtain a first gray-scale image corresponding to the first sub-image and a second gray-scale image corresponding to the second sub-image, respectively. Fourier transform processing is performed on the first gray-scale image and the second gray-scale image respectively, and normalized cross processing is performed on pixels in the processed first gray-scale image and pixels in the processed second gray-scale image, to obtain a processed image. Inverse Fourier transform processing is performed on the processed image, a peak position is determined based on a value of each pixel in the processed image, and the phase offset information between the two frames of road images is determined based on the peak position.

The normalized cross processing is a process of normalizing the pixels in the first gray-scale image and the second gray-scale image which are processed by the Fourier transform, respectively, and calculating a cross-power spectrum for various pixels in the two images after being normalized. Further, the processed images are processed by the inverse Fourier transform. This process may also be called as a normalized cross-correlation process.

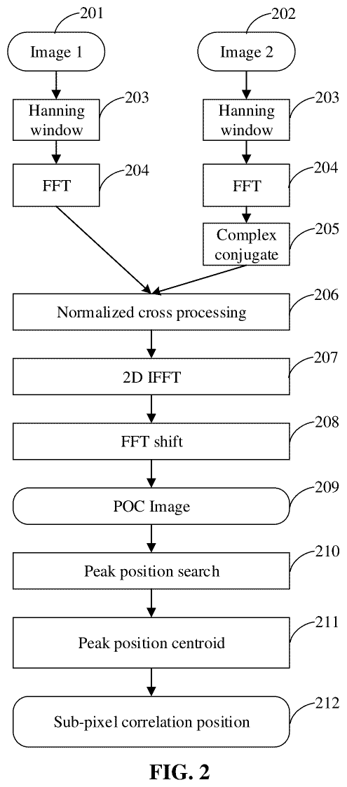

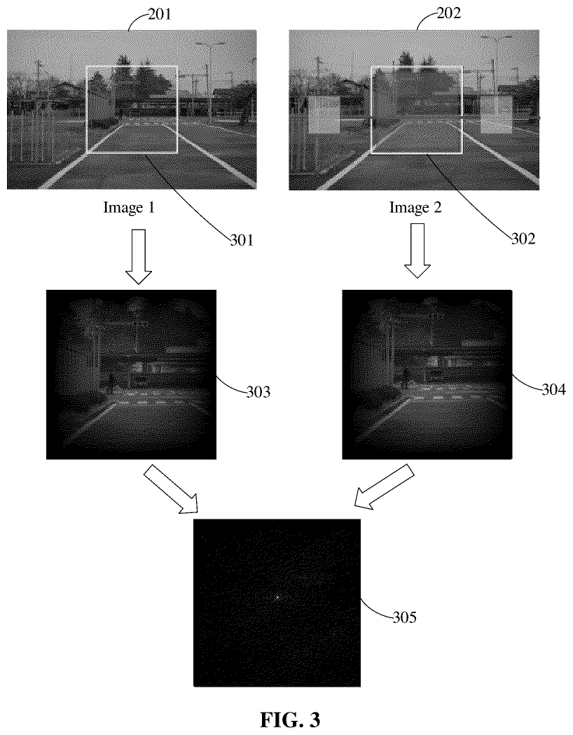

In some embodiments, with reference to FIG. 2 and FIG. 3, taking two frames of road images as an example, it is assumed that each of the two frame of road images includes one ROI, for example, a rectangular box region in image 1 (201) is the ROI of image 1, and a rectangular area in image 2 (202) is the ROI of image 2. The positions and sizes of the two ROIs in the image 1 and image 2 are the same, so that the positions and sizes of the two ROIs in the two frames of road images may be considered to be corresponding to each other.

The ROIs (the two ROIs may be referred to as ROI1 and ROI2) (301) and (302) in image 1 and image 2 are extracted, respectively, and ROI1 and ROI2 are converted into gray-scale images, respectively, to obtain the gray-scale image 1 and gray-scale image 2. Optionally, a window function (e.g., a Hanning window) (203) may be applied to the gray-scale image 1 (303) and gray-scale image 2 (304), respectively, to reduce the edge effect. The Fourier transform processing (204), such as 2-dimensional (2D) FFT or discrete Fourier transform (DFT), is performed on the processing results of gray-scale image 1 and gray-scale image 2 respectively. In this example, the FFT (2D FFT) is taken as an example. The second result (e.g., the processing result corresponding to the gray-scale image 2) is selected for performing complex conjugate (205), and a normalized cross processing (206) is performed on various corresponding pixels in the processed gray-scale image 1 and gray-scale image 2, which may be performing normalized processing element by element on the two images, which are processed by a Fourier transform, and then calculating the cross power spectrum. In some embodiments, the processed image is then processed by an inverse Fourier transform to obtain a cross-correlation image. The inverse Fourier transform process may be, for example, an inverse fast Fourier transform (IFFT) (207), or an inverse discrete Fourier transform (IDFT). The IFFT (2D IFFT) is taken as an example for description. Optionally, an FFT shift (208) and a picture order count (POC) image (209) may be performed on the cross-correlation image, and a maximum value (i.e., a peak value, such as the white dot in the last image in FIG. 3) is found by searching the values of pixels in the processed image (305). This process may be called a peak position search (210), to determine the peak position. Pixel coordinates of the peak position represent the amount of movement between the two images (also referred to as the offset of the corresponding vanishing points in the two images), that is, the phase offset information (or phase offset) between the two frames of road images.

Optionally, a sub-center is estimated by obtaining a center of gravity (or centroid) from the pixels near the peak position to determine (211) a peak position centroid, this process may be referred to as “sub-pixel estimation (or secondary pixel estimation)” or “sub-center estimation”, to determine (212) a sub-pixel correlation position.

Optionally, the size of the ROI may be a size that facilitates Fourier transform processing, for example, the number of pixels on each side of the ROI is n-th power of 2. For example, the size of the ROI may be 1024*1024. Optionally, the size of the ROI may be scaled down, for example, scaling down to 256*256, to reduce the amount of data processing. If the size of the ROI is scaled down, after obtaining the peak position coordinates, that is, after obtaining the phase offset information between the two frames of road images, the phase offset information may be processed based on the ratio for scaling down, to obtain the phase offset information with the same size as the image 1 and the image 2.

In an embodiment of the present disclosure, the phase offset information between the two frames of road images is determined, the offset is caused by acceleration or deceleration of the traveling device, or the posture changing of the traveling device relative to the ground due to the unevenness of the road surface, this posture changing representing the changing of the posture of the traveling device relative to the ground, which may be a change of pitch posture. The phase offset information represents the offset between the corresponding vanishing points in the two images, which is partly caused by the traveling of the traveling device in the horizontal direction, and partly caused by the change of the pitch posture of the traveling device. In some embodiments, the electronic device needs to determine the information of posture changing of the traveling device based on the phase offset information described above.

In some embodiments, the electronic device may convert the phase offset information based on a conversion relationship, to obtain the information of posture changing of the traveling device. The information of posture changing may refer to the information of posture changing of the traveling device in the vertical direction (also referred to as information of pitch posture changing).

In an embodiment of the present disclosure, the electronic device may predetermine reference posture information based on at least two frames of historical road images. For example, the at least two frames of historical road images may be road images acquired by the traveling device when it is traveling on a flat road surface at a uniform speed or approximately uniform speed, and the posture information of the traveling device is determined based on the at least two frames of historical road images as the reference posture information, which may also be called benchmark posture information of the traveling device. The information of posture changing obtained subsequently according to the above-mentioned technical solution of the present disclosure may take the reference posture information as a benchmark, and the posture information of the traveling device may obtained by adding the information of posture changing (the information may be a vector) and the reference posture information.

In some optional embodiments of the present disclosure, the method may also include that calibration information of the image acquisition component is updated based on the information of posture changing or the posture information of the traveling device.

In an embodiment of the present disclosure, the electronic device may update the calibration information of the image acquisition component based on the information of posture changing or the posture information of the traveling device. The calibration information may be, for example, a homography matrix. The updated calibration information is used for bird's-eye view transformation. For example, image information of at least one of the lane line or the target object may be transformed to the bird's-eye view information.

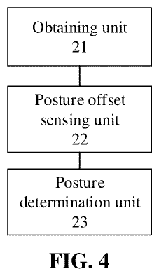

In view of the above embodiments, there is also provided an apparatus for image processing in an embodiment of the present disclosure. FIG. 4 is a first structural schematic diagram of composition of an apparatus for image processing according to an embodiment of the present disclosure. As illustrated in FIG. 4, the apparatus includes an obtaining unit 21, a posture offset sensing unit 22 and a posture determination unit 23.

The obtaining unit 21 is configured to obtain at least two frames of road images by an image acquisition component installed on a traveling device; the posture offset sensing unit 22 is configured to determine information of posture changing, of the traveling device, between two frames of road images of the at least two frames of road images by using a phase-only correlation method; and the posture determination unit 23 is configured to determine posture information of the traveling device based on the information of posture changing and reference posture information of the traveling device.

In some optional embodiments of the present disclosure, the posture offset sensing unit 22 is configured to: determine phase offset information between the two frames of road images based on regions of interest in the two frames of road images; and determine the information of posture changing, of the traveling device, between the two frames of road images based on the phase offset information.

In some optional embodiments of the present disclosure, the posture offset sensing unit 22 is further configured to determine one or at least two regions of interest in the each frame of road image. At least one of the one or at least two regions of interest has at least one of following characteristics: overlapping with horizon, or including a vanishing point.

In some optional embodiments of the present disclosure, there is no moving object in the region of interest; or a proportion of moving object(s) occupying the region of interest is less than or equal to a first threshold.

In some optional embodiments of the present disclosure, when the each frame of road image includes at least two regions of interest, the at least two regions of interest at least include a first region of interest and a second region of interest. The first region of interest includes the vanishing point.

In some optional embodiments of the present disclosure, a size of the second region of interest is smaller than a size of the first region of interest.

In some optional embodiments of the present disclosure, the second region of interest is within the first region of interest, or the second region of interest is outside the first region of interest, or the second region of interest partially overlaps with the first region of interest.

In some optional embodiments of the present disclosure, the posture offset sensing unit 22 is configured to determine the phase offset information between the two frames of road images based on region(s) of interest in each of the two frames of road images.

In some optional embodiments of the present disclosure, the posture offset sensing unit 22 is configured to, when the first region of interest includes moving object(s), determine the phase offset information between the two frames of road images based on the second regions of interest in the two frames of road images.

In some optional embodiments of the present disclosure, the posture offset sensing unit 22 is configured to, when each of region(s) of interest in each of the two frames of road images includes moving object(s), determine first phase offset information between the two frames of road images based on the regions of interest in the two frames of road images; detect a proportion of a region where the moving object(s) is located in the regions of interest in the two frames of road images respectively; and determine the phase offset information between the two frames of road images based on the proportion and the first phase offset information.

In some optional embodiments of the present disclosure, the posture offset sensing unit 22 is configured to, when each of the two frames of road images includes at least two regions of interest, determine second phase offset information between the two frames of road images based on each set of corresponding regions of interest in the two frames of road images, a position of a region of interest, in each set of corresponding regions of interest, in a road image of the region of interest corresponding to a position of the other region of interest, in the set of corresponding regions of interest, in a road image of the other region of interest; and select one piece of second phase offset information from at least two pieces of second phase offset information as the phase offset information between the two frames of road images; or, determine median phase change information among the at least two pieces of second phase offset information and determine the median phase change information as the phase offset information between the two frames of road images; or, determine an average value of the at least two pieces of second phase offset information and determine the average value as the phase offset information between the two frames of road images.

In some optional embodiments of the present disclosure, at least one region of interest is symmetrical with respect to horizon.

In some optional embodiments of the present disclosure, the number of pixels of each edge of at least one region of interest is n-th power of 2, n being a positive integer.

In some optional embodiments of the present disclosure, the posture offset sensing unit 22 is configured to: extract sub-images corresponding to the regions of interest in the two frames of road images respectively to obtain a first sub-image and a second sub-image; perform gray-scale processing on the first sub-image and the second sub-image, to obtain a first gray-scale image corresponding to the first sub-image and a second gray-scale image corresponding to the second sub-image, respectively; perform Fourier transform processing on the first gray-scale image and the second gray-scale image respectively, and perform normalized cross processing on pixels in the processed first gray-scale image and pixels in the processed second gray-scale image, to obtain a processed image; and perform inverse Fourier transform processing on the processed image, determine a peak position based on a value of each pixel in the processed image, and determine the phase offset information between the two frames of road images based on the peak position.

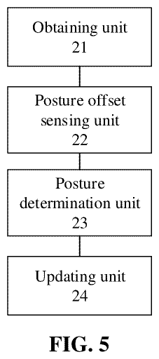

In some optional embodiments of the present disclosure, as illustrated in FIG. 5, the apparatus further includes an updating unit 24 configured to update calibration information of the image acquisition component based on the information of posture changing or the posture information of the traveling device.

In an embodiment of the present disclosure, the apparatus is applied to an electronic device. In practical applications, the obtaining unit 21, the posture offset sensing unit 22, the posture determination unit 23, and the updating unit 24 in the apparatus may all be implemented by a central processing unit (CPU), a digital signal processor (DSP), a microcontroller unit (MCU), or a field-programmable gate array (FPGA).

It should be noted that when the apparatus for image processing provided in the above embodiments performs the image processing, division of programming modules is only described for exemplary purpose. In actual applications, the above processing may be allocated to different programming modules according to needs, that is, an internal structure of the apparatus may be divided into different programming modules, to complete all or some of the above described processing. Moreover, the apparatus for image processing provided in the foregoing embodiments belongs to the same concept as the embodiments of the method for image processing. The implementation process may be understood with reference to the method embodiments, and the details will not be elaborated herein again.

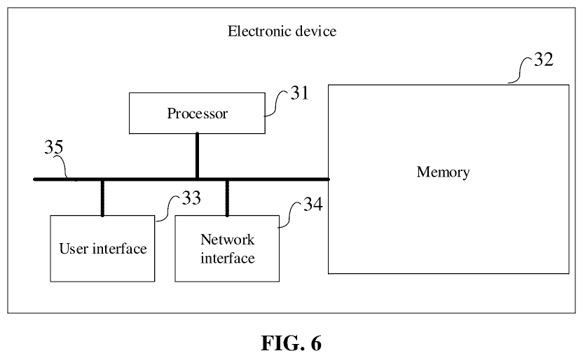

There is also provided an electronic device in an embodiment of the present disclosure. FIG. 6 is a structural schematic diagram of composition of hardware of an electronic device according to an embodiment of the present disclosure. As illustrated in FIG. 6, the electronic device includes a memory 32, a processor 31, and a computer program stored on the memory 32 and executable by the processor 31. The processor 31, when executing the computer program, performs operations of the method for image processing in the embodiments of the present disclosure.

Optionally, the electronic device may also include a user interface 33 and a network interface 34. The user interface 33 may include a display, a keyboard, a mouse, a trackball, a click wheel, a key, a button, a tactile board, a touch screen, and the like.

Optionally, various components in the electronic device are coupled with each other through a bus system 35. It is understood that the bus system 35 is used for connection and communication between these components. The bus system 35 includes a data bus as well as a power bus, a control bus and a status signal bus. However, for the sake of clarity, various buses are labeled as the bus system 35 in FIG. 6.

It can be understood that, the memory 32 may be a volatile memory or a non-volatile memory, and may include both the volatile memory and the non-volatile memory. The non-volatile memory may be a read-only memory (ROM), a programmable ROM (PROM), an erasable PROM (EPROM), an electrically EPROM (EEPROM), a ferromagnetic random access memory (FRAM), a flash memory, a magnetic surface memory, an optical disk, or a compact disc ROM (CD-ROM). The magnetic surface memory may be a magnetic disk memory or a magnetic tape memory. The volatile memory may be an RAM and is used as an external cache. Many forms of RAMs may be used through exemplary but not limitative description, for example, a static RAM (SRAM), a synchronous SRAM (SSRAM), a Dynamic RAM (DRAM), a Synchronous DRAM (SDRAM), a double data rate SDRAM (DDRSDRAM), an enhanced SDRAM (ESDRAM), a synclink DRAM (SLDRAM) and a direct rambus RAM (DR RAM). The memory 32 in the embodiments of the disclosure aims to include but be not limited to these memories and any other suitable types of memories.

The method disclosed in the above embodiments of the disclosure may be applied to or implemented by the processor 31. The processor 31 may be an integrated circuit chip and has a signal processing capability. During implementation, the operations of the foregoing method may be implemented by using a hardware integrated logic circuit in the processor 31 or implemented by using instructions in a software form. The foregoing processor 31 may be a general purpose processor, a digital signal processor (DSP), or another programmable logical device, discrete gate or transistor logical device, or discrete hardware component. The processor 31 may implement or perform methods, steps and logical block diagrams disclosed in the embodiments of the disclosure. The general purpose processor may be a microprocessor or any conventional processor and the like. Operations of the methods disclosed with reference to the embodiments of the disclosure may be directly executed and completed by means of a hardware decoding processor, or by using a combination of hardware and software modules in the decoding processor. The software module may be located in a storage medium, and the storage medium is located in the memory 32, and the processor 31 reads information in the memory 32 and completes the steps in the foregoing methods in combination with hardware of the processor.

In an exemplary embodiment, the electronic device may be implemented by one or at least two application specific integrated circuits (ASICs), DSPs, programmable logic devices (PLDs), Complex PLDs (CPLDs), FPGAs, general purpose processors, controllers, MCUs, Micro Processing Units (MPUs), or other electronic components, for performing the foregoing methods.

In an exemplary embodiment, there is also provided a computer-readable storage medium, such as a memory 32 including computer instructions which may be executed by the processor 31 in the electronic device for performing operations of the foregoing method. The computer readable storage medium may be a memory such as an FRAM, an ROM, a PROM, an EPROM, an EEPROM, a flash memory, a magnetic surface memory, an optical disc, or a CD-ROM. The computer readable storage medium may also be any device that includes one or any combination of the above-mentioned memories.

The computer-readable storage medium provided in the embodiment of the present disclosure has stored thereon a computer program which, when being executed by a processor, causes the processor to perform operations of the method for image processing in the embodiments of the present disclosure.

The computer-readable storage medium may be a tangible device that may hold and store instructions for use by the instruction execution device, and may be a volatile storage medium or a non-volatile storage medium. The computer-readable storage medium may be, for example, but not limited to, an electrical storage device, a magnetic storage device, an optical storage device, an electromagnetic storage device, a semiconductor storage device, or any suitable combination of the above. Examples (non-exhaustive list) of the computer-readable storage medium include: a portable computer disk, a hard disk, an RAM, an ROM, an erasable programmable ROM (EPROM or flash memory), an SRAM, a CD-ROM, a Digital Video Disc (DVD), a memory stick, a floppy disk, a mechanical encoding device, such as a punch card or in-recess bump structure on which instructions are stored, and any suitable combination of the above. As used herein, the computer-readable storage medium is not to be explained as an instantaneous signal itself, such as a radio wave or other freely propagating electromagnetic wave, an electromagnetic wave propagating through a waveguide or any other transmission medium (e.g., an optical pulse through a fiber optic cable), or an electrical signal transmitted through a wire.

There is also provided a computer program in an embodiment of the present disclosure. The computer program includes computer-readable codes which, when being read and executed by a computer, cause the computer to perform some or all of the operations of the method in any embodiment of the present disclosure.

The methods disclosed in several method embodiments provided in the present disclosure may be arbitrarily combined without conflict to obtain new method embodiments.

The features disclosed in several product embodiments provided in the present disclosure may be arbitrarily combined without conflict to obtain new product embodiments.

The features disclosed in several method or apparatus embodiments provided in the present disclosure may be arbitrarily combined without conflict to obtain new method or apparatus embodiments.

In the several embodiments provided in this disclosure, it should be understood that the disclosed device and method may be implemented in other schemes. The described device embodiment is merely exemplary. For example, the unit division is merely logical function division and there may be other division in actual implementation. For example, at least two units or components may be combined or integrated into another system, or some features may be ignored or not performed. In addition, the displayed or discussed mutual couplings or direct couplings or communication connections of various parts may be implemented through some interfaces. The indirect couplings or communication connections between the devices or units may be implemented in electrical, mechanical or other forms.

The units described as separate parts may or may not be physically separate, and parts displayed as units may or may not be physical units, they may be located in one position, or may be distributed on at least two network units. Some or all of the units may be selected according to actual needs to achieve the purpose of the solution in the embodiments of the present disclosure

In addition, functional units in the embodiments of this application may be all integrated into one processing unit, or each of the units may exist as an individual unit, or two or more units may be integrated into one unit. The integrated units may be implemented in the form of hardware, or may be implemented in the form of hardware combined with software functional units.

A person of ordinary skill in the art will understand that all or part of the steps for implementing the above-mentioned method embodiments can be completed by program instruction-related hardware. The program may be stored in a computer-readable storage medium, and when the program is executed, the operations including the above-mentioned method embodiments are executed. The aforementioned storage medium includes a removable storage device, an ROM, an RAM, a magnetic disk or an optical disk, and various media that can store program codes.

Alternatively, when the integrated units in the embodiments of the present disclosure may be stored in a computer-readable storage medium when they are implemented in form of a software functional module and sold or used as an independent product. Based on such understanding, the technical solutions of this application essentially, or the part contributing to the prior art may be implemented in the form of a software product. The computer software product is stored in a storage medium, and includes several instructions for instructing a computer device (which may be a personal computer, a server, a network device, and the like) to perform all or a part of the method described in the embodiment of the disclosure. The foregoing storage medium includes: any medium that can store program codes, such as a removable storage device, an ROM, an ROM, a magnetic disk, or an optical disk.

The foregoing descriptions are merely implementations of this disclosure, but are not intended to limit the scope of protection of this disclosure. Any variation or replacement readily figured out by a person skilled in the art within the technical scope disclosed in this disclosure shall fall within the scope of protection of this disclosure. Therefore, the scope of protection of the disclosure shall be subject to the scope of protection of the claims.

1. A method for image processing, comprising:
obtaining at least two frames of road images by an image acquisition component installed on a traveling device;
determining information of posture changing, of the traveling device, between two frames of road images of the at least two frames of road images by using a phase-only correlation method; and
determining posture information of the traveling device based on the information of posture changing and reference posture information of the traveling device.

2. The method of claim 1, wherein determining the information of posture changing of the traveling device between the two frames of road images of the at least two frames of road images by using the phase-only correlation method comprises:
determining phase offset information between the two frames of road images based on regions of interest in the two frames of road images; and
determining the information of posture changing, of the traveling device, between the two frames of road images based on the phase offset information.

3. The method of claim 2, wherein region(s) of interest in each frame of road image is determined by:
determining one or at least two regions of interest in the each frame of road image, wherein at least one of the one or at least two regions of interest has at least one of following characteristics: overlapping with horizon, or comprising a vanishing point.

4. The method of claim 2, wherein there is no moving object in the region of interest; or
a proportion of moving object(s) occupying the region of interest is less than or equal to a first threshold.

5. The method of claim 3, wherein when the each frame of road image comprises at least two regions of interest, the at least two regions of interest at least comprise a first region of interest and a second region of interest; and
the first region of interest comprises the vanishing point.

6. The method of claim 5, wherein a size of the second region of interest is smaller than a size of the first region of interest.

7. The method of claim 5, wherein the second region of interest is within the first region of interest, or the second region of interest is outside the first region of interest, or the second region of interest partially overlaps with the first region of interest.

8. The method of claim 4, wherein determining the phase offset information between the two frames of road images based on the regions of interest in the two frames of road images comprises:
determining the phase offset information between the two frames of road images based on region(s) of interest in each of the two frames of road images.

9. The method of claim 5, wherein the first region of interest comprises moving object(s), and determining the phase offset information between the two frames of road images based on the regions of interest in the two frames of road images comprises:
determining the phase offset information between the two frames of road images based on the second regions of interest in the two frames of road images.

10. The method of claim 2, wherein each of region(s) of interest in each of the two frames of road images comprises moving object(s), and determining the phase offset information between the two frames of road images based on the regions of interest in the two frames of road images comprises:
determining first phase offset information between the two frames of road images based on the regions of interest in the two frames of road images; and
detecting a proportion of a region where the moving object(s) is located in the regions of interest in the two frames of road images respectively, and determining the phase offset information between the two frames of road images based on the proportion and the first phase offset information.

11. The method of claim 2, wherein each of the two frames of road images comprises at least two regions of interest, and determining the phase offset information between the two frames of road images based on the region of interests in the two frames of road images comprises:
determining second phase offset information between the two frames of road images based on each set of corresponding regions of interest in the two frames of road images, wherein a position of a region of interest, in each set of corresponding regions of interest, in a road image of the region of interest correspond to a position of the other region of interest, in the set of corresponding regions of interest, in a road image of the other region of interest; and
selecting one piece of second phase offset information from at least two pieces of second phase offset information as the phase offset information between the two frames of road images; or, determining median phase change information among the at least two pieces of second phase offset information and determining the median phase change information as the phase offset information between the two frames of road images; or, determining an average value of the at least two pieces of second phase offset information and determining the average value as the phase offset information between the two frames of road images.

12. The method of claim 2, wherein at least one region of interest is symmetrical with respect to horizon.

13. The method of claim 2, wherein a number of pixels of each edge of at least one region of interest is n-th power of 2, n being a positive integer.

14. The method of claim 2, wherein determining the phase offset information between the two frames of road images based on the regions of interest in the two frames of road images comprises:
extracting sub-images corresponding to the regions of interest in the two frames of road images respectively to obtain a first sub-image and a second sub-image;
performing gray-scale processing on the first sub-image and the second sub-image, to obtain a first gray-scale image corresponding to the first sub-image and a second gray-scale image corresponding to the second sub-image, respectively;
performing Fourier transform processing on the first gray-scale image and the second gray-scale image respectively, and performing normalized cross processing on pixels in the processed first gray-scale image and pixels in the processed second gray-scale image, to obtain a processed image; and
performing inverse Fourier transform processing on the processed image, determining a peak position based on a value of each pixel in the processed image, and determining the phase offset information between the two frames of road images based on the peak position.

15. The method of claim 2, further comprising:
updating calibration information of the image acquisition component based on the information of posture changing or the posture information of the traveling device.

16. An electronic device, comprising a memory, a processor, and a computer program stored in the memory and executable by the processor, wherein the processor, when executing the computer program, performs operations comprising:
obtaining at least two frames of road images through an image acquisition component installed on a traveling device;
determining information of posture changing, of the traveling device, between two frames of road images of the at least two frames of road images by using a phase-only correlation method; and
determining posture information of the traveling device based on the information of posture changing and reference posture information of the traveling device.

17. The electronic device of claim 16, wherein the processor, when executing the computer program, further performs operations comprises:
determining phase offset information between the two frames of road images based on regions of interest in the two frames of road images; and
determining the information of posture changing, of the traveling device, between the two frames of road images based on the phase offset information.

18. The electronic device of claim 17, wherein the processor, when executing the computer program, further performs operations comprises:
determining one or at least two regions of interest in each frame of road image, wherein at least one of the one or at least two regions of interest has at least one of following characteristics: overlapping with horizon, or comprising a vanishing point.

19. The electronic device of claim 18, wherein there is no moving object in the region of interest; or
a proportion of moving object(s) occupying the region of interest is less than or equal to a first threshold.

20. A non-transitory computer-readable storage medium, wherein a computer program is stored in the non-transitory computer-readable storage medium, and when the computer program is executed by a processor, the processor is caused to implement operations comprising:
obtaining at least two frames of road images through an image acquisition component installed on a traveling device;
determining information of posture changing, of the traveling device, between two frames of road images of the at least two frames of road images by using a phase-only correlation method; and
determining posture information of the traveling device based on the information of posture changing and reference posture information of the traveling device.
